(19) United States
(12) Patent Application Publication
(10) Pub. No.: US 2020/0007645 A1
(43) Pub. Date: Jan. 2, 2020

(54) MANAGING PROFILE DATA FOR MULTIPLE ENTERPRISE IDENTITIES

(71) Applicant: Microsoft Technology Licensing, LLC, Redmond, WA (US)

(72) Inventors: Dianxia Yang, Santa Clara, CA (US); Mark I. Sandori, San Jose, CA (US); Albert M. Ho, Santa Clara, CA (US); Mohan Krishnan, Fremont, CA (US); Viktar Starynski, Sunnyvale, CA (US)

(73) Assignee: Microsoft Technology Licensing, LLC, Redmond, WA (US)

(21) Appl. No.: 16/020,729

(22) Filed: Jun. 27, 2018

(51) Int. Cl. H04L 29/08; G06F 17/30; H04L 29/06

(52) U.S. Cl. CPC H04L 67/306; G06Q 50/01; H04L 63/102; G06F 17/30867

(57) ABSTRACT

The disclosed embodiments provide a system for processing a request for profile data. During operation, the system obtains, from the request, an identifier for a member in a user community and a first non-global scope. Next, the system matches the identifier to a central profile record and locates a scoped profile record for the member. If the request is a read request, the system retrieves a first field from the scoped profile record and a second field from the central profile record and transmits the first and second fields in a response to the request without including, in the response, additional fields that are outside of the first non-global scope or the global scope. If the request is a write request, the system stores an update to the first field in the scoped profile record without modifying the first field in profile records that are outside of the first non-global scope.

### BACKGROUND

### Field

The disclosed embodiments relate to identity management in online networks. More specifically, the disclosed embodiments relate to techniques for managing profile data for multiple enterprise identities.

### Related Art

Online networks may include nodes representing individuals and/or organizations, along with links between pairs of nodes that represent different types and/or levels of social familiarity between the entities represented by the nodes. For example, two nodes in network may be connected as friends, acquaintances, family members, classmates, and/or professional contacts. Online networks may further be tracked and/or maintained on web-based networking services, such as online professional networks that allow the individuals and/or organizations to establish and maintain professional connections, list work and community experience, endorse and/or recommend one another, run advertising and marketing campaigns, promote products and/or services, and/or search and apply for jobs.

In turn, online networks may facilitate business activities such as sales, marketing, and/or recruiting by the individuals and/or organizations. For example, recruiters may use the online professional network to search for candidates for job opportunities and/or open positions. At the same time, job seekers may use the online professional network to enhance their professional reputations, conduct job searches, reach out to connections for job opportunities, and apply to job listings.

Each member of an online network may additionally maintain a profile of personal, demographic, and/or professional data related to the member. For example, a member of an online professional network may have a profile that includes a first name, last name, profile photo, location, title, summary, work experience, education, skills, connections, groups, and/or other fields related to the member's profession, career, and/or use of the online professional network. To protect the member's privacy, portions of the profile may only be viewed by other entities that meet certain requirements, such as being connected to the member, sharing connections with the member, and/or belonging to the same group as the member.

Consequently, use of online networks can be improved by securing and/or managing access to profile data for entities in online networks.

### BRIEF DESCRIPTION OF THE FIGURES

FIG. 1 shows a schematic of a system in accordance with the disclosed embodiments.

FIG. 2 shows a system for processing requests for profile data in accordance with the disclosed embodiments.

FIG. 3 shows a flowchart illustrating the processing of a request for profile data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The disclosed embodiments provide a method, apparatus, and system for processing data. More specifically, the disclosed embodiments provide a method, apparatus, and system for managing profile data for multiple user identities, such as different versions of an enterprise user profile that are used to access multiple products and/or applications. Because each product or application is associated with a different usage context, the fields and/or values of a user's profile may vary as the profile is viewed and/or accessed within a given product or application.

For example, a user's enterprise profile may represent the user's identity as an employee of a company. The company may have paid access to multiple products that can be accessed and/or used with the enterprise profile, such as products related to sales, marketing, recruiting, advertising, and/or educational technology. As a result, the enterprise profile may include fields that are specific to one product, such as a hiring project or requisition in the recruiting product, a customer relationship management (CRM) status in the sales product, a learner profile in the educational technology product, and/or an advertising campaign in the advertising product. Conversely, a number of fields in the enterprise profile may be shared across products, such as fields related to the user's name, location, title, department, and/or nickname.

A conventional technique for managing user identities may store a single copy of profile data for each user and allowing access to the profile data for all products to which the user has access. As a result, the same profile data may be shown within every product, independently of the relevance of each profile attribute to a given product. For example, the profile data may include hiring projects assigned to the user in a recruiting product, which may be shown within an educational technology product that the user uses for online learning. Moreover, administrators and/or teams may overwrite the profile data during customization of the profile data for specific products. For example, a single profile attribute for the user's role may be overwritten multiple times as administrators of different products attempt to define the user's role within the context of those products.

To manage different versions of profile data with different products and/or usage contexts, a central profile record may be stored for each user, along with differentiated mappings from the central profile record to one or more “scoped” profile records for the user. The central profile record may include fields in a general, undifferentiated representation of the user's identity (e.g., name, nickname, location, title, department, etc.), while each scoped profile record may include fields that correspond to a narrower scope or usage context (e.g., learning profile, hiring projects, advertising campaigns, etc.).

In turn, the visibility of the profile data may be managed with respect to the scope used to access the profile data. If a read or write request for the profile data does not specify a scope, the central profile record may be used to process the request. If a read or write request for the profile includes a narrower scope such as a specific product and/or usage context within the product, the mapping between the central profile record and a scoped profile record that is maintained under the scope may be used to retrieve the scoped profile record, and the central profile record and/or scoped profile record may be used to process the request.

For example, a read request may include a number of fields in the profile data. A first field may be found in both the central profile record and the scoped profile record, a second field may be found only in the scoped profile record, and a third field may be found only in the central profile record. To process the read request, the first and second fields may be retrieved from the scoped profile record because the first field in the scoped profile record overrides the same field in the central profile record and because the second field is not present in the central profile record. On the other hand, the third field may be retrieved from the central profile record because the scoped profile record does not have a corresponding field that overrides the third field. As a result, the disclosed embodiments may avert visibility concerns and/or overwriting of profile data associated with an entirely centralized profile without incurring the complexity associated with maintaining and/or binding completely separate profiles for the user.

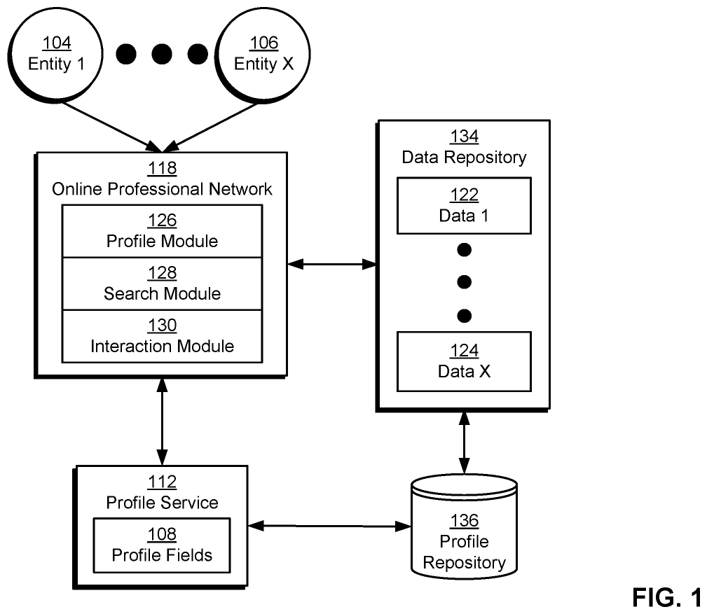

As shown in FIG. 1, management of multiple user identities may be associated with a user community, such as an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

Data in data repository 134 may also be synchronized with a profile repository 136 that stores profile data for the entities. For example, profile repository 136 may store, for members of online professional network 118, profile fields that include a first name, last name, date of birth, location, postal address, email address, headline, summary, employment history, education, skills, connections, recommendations, groups, and/or other personal, professional, or demographic attributes. In another example, profile repository 136 may store, for companies and/or organizations in online professional network 118, profile fields such as a name, location, postal address, email address, industry, size, state of incorporation, overview, logo, website, year founded, and/or other relevant or identifying attributes. In other words, profile repository 136 may contain profile fields 108 that describe or pertain to an entity's identity in online professional network 118.

A profile service 112 uses data in profile repository 136 to process requests for profile data from profile module 126, search module 128, interaction module 130, and/or other components of online professional network 118. For example, profile service 112 may use the requests to perform reads, writes, searches, and/or other operations related to profile fields 108 in profile repository 134. During processing of the requests, profile service 112 may generate results of the requests and return the results in responses to the requests. Such request processing may be performed in a real-time, near-real-time, and/or offline basis.

Profile service 112 processes each request by reading and/or writing the requested profile fields from profile repository 136. For example, profile service 112 may obtain an identifier for a member from a read request and use the identifier to perform a lookup of profile fields 108 in a database and/or other data store providing profile repository 136. Profile service 112 may include the profile fields in a result of the read request and transmit the result in a response to the read request.

Profile service 112 further includes functionality to manage member identities and/or profile data with respect to access to or use of enterprise or paid products that are offered by or through online professional network 118. Such products may include, but are not limited to, recruiting solutions, sales solutions, marketing solutions, educational technology products, advertising solutions, and/or other solutions that are offered to personal or enterprise customers with identities (e.g., member accounts, profiles, etc.) on online professional network 118. For example, a company may purchase a subscription to a product, which includes use of the product by a certain number of employees of the company. An administrative user in the company may manage the subscription by logging in to online professional network 118 with his/her identity and accessing an “account center” portal in online professional network 118. Within the portal, the administrative user may add employees of the company to the subscription and/or remove employees from the subscription using the employees' identities with online professional network 118.

In one or more embodiments, profile service 112 maintains multiple versions and/or sets of profile data in profile repository 136 for members of online professional network 118 with access to one or more of such products. When a member registers with online professional network 118, profile service 112 may create a “consumer” profile representing the member's identity within online professional network 118. Profile attributes stored under the consumer profile may include the member's name, contact information, title, industry, seniority, employment history, education, connections in online professional network 118, group memberships in online professional network 118, and/or other fields related to the member's general use of online professional network 118.

When the member is employed by a company with paid subscriptions and/or accounts for accessing one or more products offered by or through online professional network 118, profile service 112 may create an “enterprise” profile representing the member's identity with respect to use of the products under the company's subscriptions and/or accounts. For example, profile service 112 may create the enterprise profile when an administrative user for the member's company imports the member into the company's subscription account. Profile attributes stored under the enterprise profile may, in turn, include employer- and product-specific fields such as a group or department of which the member is a part, a score or rating of the member in the context of using a specific product, one or more projects to which the member is assigned, and/or a nickname or alias of the member within the employer and/or a given product.

To improve the member's user experience with online professional network 118 and/or products offered by or through online professional network 118, profile service 112 may link multiple sets of the member's profile data to one another. For example, profile service 112 may bind the member's enterprise profile to the consumer profile instead of maintaining entirely separate profiles for the member's consumer and enterprise identities. In turn, the member's connections and/or professional attributes in the consumer profile may be used to generate insights that can be used to make recommendations during the member's use of a product, automate workflows for the member within the product, and/or enhance features of the product for the member. At the same time, the member's enterprise profile can be modified and/or deleted to reflect changes to the member's employment and/or disable the member's access to the products.

On the other hand, a single profile may be used to manage the member's access to all products, which may complicate the management of distinct “identities” and/or profile attributes for the member within each product. For example, all profile attributes stored in the member's enterprise profile may be accessible to all products to which the member has access, independently of the relevance of each profile attribute to a given product. In another example, administrators and/or teams for different products may overwrite one another's data when the data is stored in a single enterprise profile.

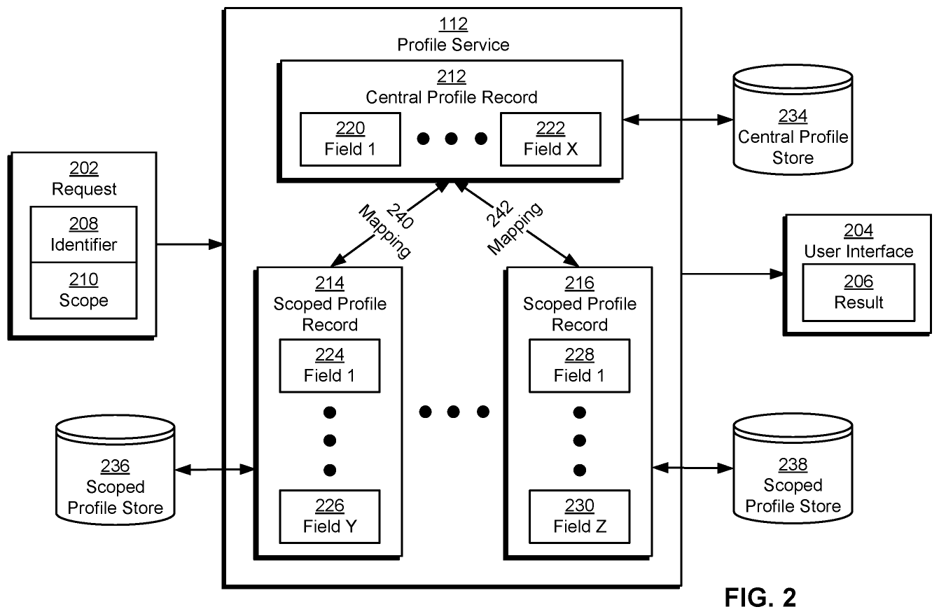

In one or more embodiments, profile service 112 manages multiple identities associated with members of online professional network 118 by maintaining a centralized identity or profile for each member while applying different scopes to individual profile fields 108 in the member's profile. In turn, profile service 112 processes requests for profile data using the centralized identity and/or scopes. As shown in FIG. 2, such a request 202 includes an identifier 208 for a member of an online network or other type of community (e.g., online professional network of FIG. 1), as well as a scope 210 associated with the member's profile.

Identifier 208 represents a single profile or identity for the member within the community. For example, identifier 208 may include a member identifier for the member in the community, an employee identifier of the member in a company, an email address for the member, and/or a username of the member (e.g., for logging in to the community).

Identifier 208 may be used to distinguish between multiple versions of a single profile for the member and separate profiles for the member. For example, the member may have two enterprise profiles that are registered or opened under two different email addresses (e.g., for two companies for which the member currently works). In this instance, each email address may act as a unique identifier 208 for the corresponding enterprise profile. Alternatively, the member may have one enterprise profile that lists two email addresses, with either or both email addresses functioning as a unique identifier 208 for the enterprise profile. In general, a given enterprise profile may be registered under one or more identifiers (e.g., identifier 208) that uniquely identify the enterprise profile. Once a given identifier is used with a given profile, creation of another account and/or profile using the identifier may be prohibited.

Scope 210 represents a context and/or use case associated with the member's profile or identity. For example, scope 210 may be tied to a specific product to which the account has access. Scope 210 may also, or instead, be limited to a more granular usage context within the product, such as a hiring project or requisition in a recruiting product, a customer relationship management (CRM) status in a sales product, a learner profile in an educational technology product, and/or an advertising campaign in an advertising product. Finally, scope 210 may include a global scope that encompasses the broadest representation of the member's profile or identity, such as the member's identity and/or enterprise profile as an employee of a company with a subscription account for accessing paid products offered by or through the community and/or the member's identity in the community.

In one or more embodiments, different versions of a member's profile (e.g., enterprise profile) and/or identity are managed using scope 210, a central profile record 212, and/or one or more scoped profile records 214-216. Central profile record 212 may include a number of fields (e.g., field 1 220, field x 222) that can be accessed under the global scope 210. For example, central profile record 212 may represent the member's enterprise profile under a given employer and/or subscription account. As a result, fields in central profile record 212 may include, but are not limited to, the member's name, title, location, profile photo, email address with the employer, username with the employer, number of years with the employer, manager, direct reports, department, team, and/or other attributes related to the member's employment with the employer.

On the other hand, fields in scoped profile record 214 (e.g., field 1 224, field y 226) and fields in scoped profile record 216 (e.g., field 1 228, field z 230) are accessed under more granular, non-global scopes. Continuing with the previous example, scoped profile records 214-216 may represent versions of the member's enterprise profile under different products and/or under different usage contexts within a given product. Scoped profile record 214 may be accessed under one scope 210 (e.g., one product and/or usage context), and scoped profile 216 may be accessed under a different scope 210 (e.g., a different product and/or a usage context). As a result, fields in scoped profile records 214-216 may include, but are not limited to, a nickname or username for the member under each product, courses taken by the member within an educational technology product, a recruiting team and/or hiring projects associated with the member in a recruiting product, a score representing the member's ability to conduct social selling within a sales product, and/or advertising campaigns managed by the member in an advertising product. In other words, central profile record 212 and scoped profile records 214-216 may represent different “versions” of the member's profile that fall under different scopes (e.g., scopes 210).

As shown in FIG. 2, central profile record 212 is stored in a central profile store 234, scoped profile record 214 is stored in a scoped profile store 236, and scoped profile record 216 is stored in another scoped profile store 238. Central profile store 234 and scoped profile stores 236-238 may include database tables, databases, files, directories, filesystems, disk drives, servers, partitions within a profile repository (e.g., profile repository 136 of FIG. 1), and/or other mechanisms for storing data that are separated or distinct from one another. In addition, each of central profile store 234 and scoped profile stores 236-238 may contain profile data under a given scope 210. For example, central profile store 234 may include profile data under the global scope, and each scoped profile store may contain profile data under a different non-global scope pertaining to a product and/or usage context.

When a given request 202 for profile data is received, profile service 112 uses identifier 208 in request 202 to retrieve a corresponding central profile record 212 from central profile store 234. For example, profile service 112 may perform a lookup of central profile store 234 using identifier 208 (and an optional account identifier for an employer of the member) to obtain central profile record 212 for the member. As mentioned above, central profile record 212 may be the broadest representation of one instance of a member's profile. As a result, central profile record 212 may be used as a starting point for processing all requests for profile data associated with the corresponding identifier 208.

Next, profile service 112 processes request 202 based on scope 210. When scope 210 is global, profile service 112 performs all processing related to request 202 using only central profile record 212. For example, profile service 112 may process a read request 202 by retrieving some or all fields from central profile record 212 and returning the fields in a result 206 of request 202. In another example, profile service 112 may process a write request 202 by obtaining field names and field values from parameters of request 202 and updating the corresponding fields in central profile record 212.

When scope 210 is non-global, profile service 112 uses central profile record 212, one or more mappings 240-242, and one or more scoped profile records 214-216 to process request 202. First, profile service 112 uses scope 210 and a mapping (e.g., mappings 240-242) to locate a corresponding scoped profile record for the member. Each mapping 240-242 may link central profile record 212 and/or identifier 208 to a scoped profile record for the same identifier 208. Each mapping 240-242 may also, or instead, connect central profile store 234 and a scoped profile store (e.g., scoped profile stores 236-238) containing scoped profile records represented by a corresponding scope 210.

More specifically, profile service 112 may use scope 210 as a key for retrieving the corresponding mapping from central profile record 212, central profile store 234, and/or another source. For example, each mapping 240-242 may specify a certain scope, along with a location (e.g., address, path, offset, unique identifier, etc.) of a scoped profile record and/or scoped profile store represented by the specified scope. Profile service 112 may match scope 210 in request 202 to the scope in a corresponding mapping and use the location of the scoped profile record in the mapping to directly retrieve the scoped profile record from the corresponding scoped profile store. Profile service 112 may also, or instead, obtain a name or location of a scoped profile store from the mapping and use identifier 208 to perform a lookup of the scoped profile record within the scoped profile store.

Profile service 112 then uses the scoped profile record and/or central profile record 212 to process request 202. As mentioned above, the scoped profile record may store profile fields that are accessed under a non-global scope 210. As a result, profile service 112 may process a read request 202 with a given identifier 208 and non-global scope 210 by obtaining requested fields from the scoped profile record whenever possible, and only obtaining a requested field from the central profile record when the field does not exist in the scoped profile record. In other words, profile fields in the scoped profile record may override the same profile fields in central profile record 212. On the other hand, if a scoped profile record represented by identifier 208 and scope 210 cannot be found, profile service 112 responds to the read request with a result 206 indicating a lack of profile data for the member (because a profile for the member does not exist under scope 210).

An example read request 202 may have the following form:

GET d2://enterpriseProfile?account=1234&id=1&scope=A

In the above request, an “account” with a value of 1234 may represent a company with paid access to one or more products in an online network. An “id” with a value of 1 may represent identifier 208 for a member with an enterprise profile under the company's subscription account for accessing the product(s). A “scope” with a value of “A” may represent a non-global scope 210 for retrieving the enterprise profile, such as a product for which the company has paid access and/or a usage context within the product.

If a scoped profile record cannot be found for the values of “account,” “id,” and “scope” in the request, profile service 112 may respond to the request with a “resource not found” message. If a scoped profile record is found for the values of “account,” “id,” and “scope” in the request, profile service 112 may respond to the request with all requested fields in the scoped profile record, as well as any requested fields that are not in the scoped profile record but are in central profile record 212 for the same “id.”

For example, profile service 112 may use the parameters of the request to retrieve a central profile record (e.g., central profile record 212) for the “account” of 1234 and the “id” of 1 from central profile store 234. The central profile record may include the following fields:

name: James Smith

nickname: Jim

title: Senior Director

employer: XYZ Co.

Next, profile service 112 may use the “scope” of “A” from the request and a mapping (e.g., mappings 240-242) associated with the scope and the central profile record to retrieve a scoped profile record with the same “account” of 1234, the “id” of 1, and the “scope” of “A” from a scoped profile store (e.g., scoped profile store 236-238). The scoped profile record may include the following fields:

nickname: Jay

title: Senior Director of Sales

location: New York, N.Y.

Profile service 112 may then generate a result of the request using all fields in the scoped profile record and any fields that are in the central profile record but not in the scoped profile record. In turn, the result may include the following fields:

name: James Smith

nickname: Jay

title: Senior Director of Sales

employer: XYZ Co.

location: New York, N.Y.

The “name” and “employer” fields are populated with values from the central profile record, and the “location” field is populated with a value from the scoped profile record because the central profile record lacks the “location” field. Although the central profile record contains the “nickname” and “title” fields, the result may include values of the fields from the scoped profile record because the scoped profile record represented by the scope specified in the request overrides the central profile record.

Another example read request 202 may have the following form:

GET d2://enterpriseProfile?account=1234&id=1

The above request has the same “account” and “id” values as the previous example request but lacks the “scope” from the previous example request. As a result, profile service 112 may process the above request using a global scope for the profile data by retrieving the central profile record for the “account” of 1234 and the “id” of 1 from central profile store 234 and including fields from the central profile record in a result of the request.

Profile service 112 processes a write request 202 with a given identifier 208 and non-global scope 210 by writing the requested data to the corresponding fields in the scoped profile record instead of to central profile record 212. A subsequent read request with a different scope may be processed by retrieving the requested fields from central profile record 212 and/or a different scoped profile record, thereby ensuring that changes made using the write request do not affect profile data that is stored outside of scope 210.

If a scoped profile record cannot be found using identifier 208 and scope 210 in a write request 202, profile service 112 may create the scoped profile record (e.g., in a scoped profile store representing scope 210) before writing the corresponding fields to the scoped profile record. Alternatively, profile service 112 may respond to the write request with a result 206 indicating a nonexistent profile for the member (e.g., if a different type of request is used to create scoped profile records).

When request 202 specifies the deletion of profile data for a given identifier 208 and non-global scope 210, profile service 112 uses scope 210 to identify a corresponding mapping and/or scoped profile record affected by the deletion. Profile service 112 then deletes the mapping and/or scoped profile record to prevent subsequent reading and/or writing of fields in the scoped profile record. When scope 210 is global, profile service 112 may delete central profile record 212 and/or a mapping of identifier 208 to central profile record 212, in lieu of or in addition to deleting any mappings 240-242 between central profile record 212 and one or more scoped profile records 214-216 for the same identifier 208 and/or the scoped profile records.

After profile service 112 generates result 206 from request 202, one or more portions of result 206 may be displayed within a user interface 204. For example, user interface 204 may be provided by an “account center” portal of the online network to allow administrative users at various companies to manage licenses or subscriptions for accessing paid products in the online network and/or manage access to the products by other members at the companies. An administrative user may specify scope 210 within user interface 204 by navigating to a portion of the portal for managing a specific product or usage context in the product and/or specifying the product or usage context using one or more user-interface elements. The administrative user may also select and/or specify a member employed by the same company (e.g., by the member's name, username, email address, member identifier, and/or other representation of identifier 208) to create, view, modify, and/or delete the member's profile data under the specified scope 210. When the administrative user switches to a different scope 210, user interface 204 may be updated with a different version of the member's profile data to reflect the new scope. In turn, changes made to the profile data may be stored under a scoped profile record for the current scope to prevent the changes from affecting other versions of the profile data that exist outside of the current scope.

By maintaining profile fields in separate profile records under different scopes, profile service 112 may maintain a centralized profile for each member while allowing customized “views” of the profile to accommodate different use cases and/or contexts associated with the member's identity. In turn, profile service 112 may avert visibility concerns and/or overwriting of profile data associated with an entirely centralized profile without incurring the complexity associated with maintaining and/or binding separate profiles for the same member. Consequently, profile service 112 may improve the performance, flexibility, and/or customizability of identity management technologies and/or applications, computer systems, and/or network-enabled devices for executing or accessing the identity management technologies.

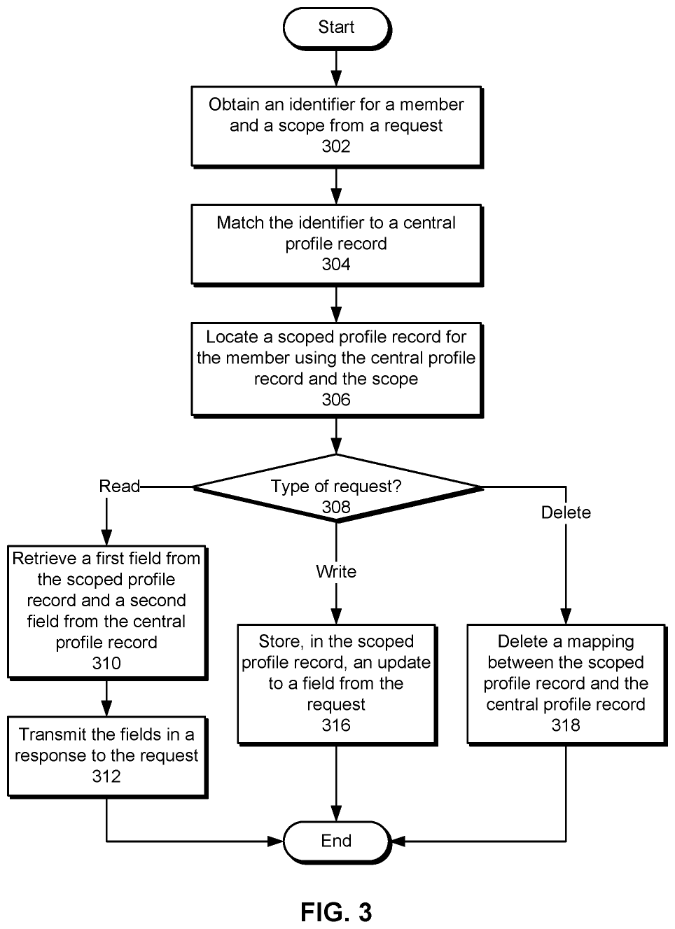

FIG. 3 shows a flowchart illustrating the processing of a request for profile data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, an identifier for a member and a scope are obtained from a request for profile data in an online network (operation 302). The identifier may include a member identifier within the online network, an employee identifier, an email address, a username, and/or other personally identifying information for the member. The scope may be a non-global scope that pertains to an account with the online network, a product offered by the online network, and/or a usage context within the product.

Next, the identifier is matched to a central profile record for the member (operation 304). For example, the identifier may be used as a key for accessing the central profile record from a central profile store. The central profile record may be associated with a global scope, which allows fields in the central profile record to be accessed from all other scopes associated with the identifier.

A scoped profile record for the member is then located using the central profile record and the scope (operation 306). For example, a mapping associated with the central profile record and the scope may be identified (e.g., by retrieving the mapping from the central profile record and/or performing a lookup of the mapping using the identifier and/or one or more fields of the central profile record), and a location of the scoped profile record may be obtained using the mapping.

The request may then be processed based on the type of the request (operation 308). If the request is a read request, a first field is retrieved from the scoped profile record, and a second field is retrieved from the central profile record (operation 310). The first field in the scoped profile record may be retrieved to override the same field in the central profile record, while the second field in the central profile record may be retrieved when the second field is missing from the scoped profile record. The fields are then transmitted in a response to the request (operation 312). The response may further omit additional fields in profile records that are outside of the scope and/or the global scope represented by the central profile record. If the request is a read request and a scoped profile record cannot be found for the specified scope, the response may indicate a lack of profile data for the member.

If the request is a write request, an update to a field from the request is stored in the scoped profile record (operation 316). The same field may remain unmodified in the central profile record and/or other profile records outside of the scope.

If the request is a delete request, a mapping between the scoped profile record and the central profile record is deleted (operation 318). The scoped profile record may optionally also be deleted, while the central profile record may be unmodified to allow the member's profile and/or identity to exist under other scopes, both global and non-global.

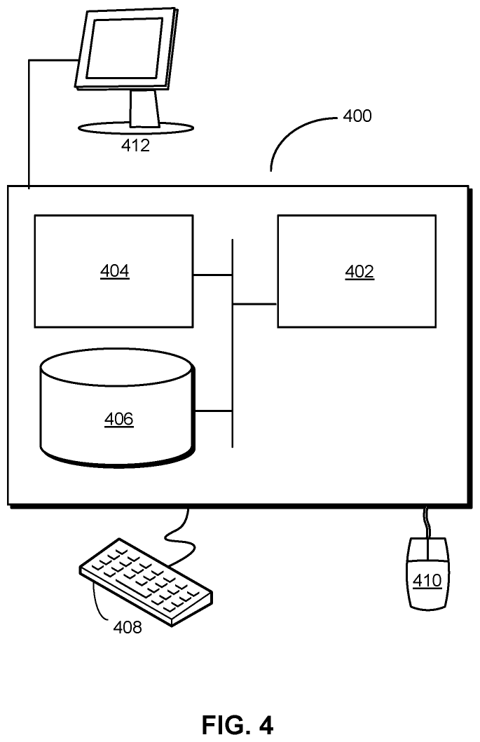

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing a request for profile data. The system includes a profile service that obtains, from the request, an identifier for a member in the online network and a non-global scope. Next, the profile service matches the identifier to a central profile record represented by a global scope. The profile service then locates a scoped profile record for the member using the central profile record and the non-global scope.

If the request is a read request, the profile service retrieves a first field from the scoped profile record and a second field from the central profile record. The profile service then transmits the first and second fields in a response to the request without including, in the response, additional fields in profile records that are outside of the non-global scope or the global scope. If the request is a write request, the profile service stores an update to the first field in the scoped profile record without modifying the first field in profile records for the member that are outside of the non-global scope.

In addition, one or more components of computer system 400 may be remotely located and connected to the other components over a network. Portions of the present embodiments (e.g., profile service, user interface, online professional network, central profile store, scoped profile stores, etc.) may also be located on different nodes of a distributed system that implements the embodiments. For example, the present embodiments may be implemented using a cloud computing system that processes queries of profile data for a set of remote members and/or entities.

By configuring privacy controls or settings as they desire, members of a social network, online professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members, privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining, from a first request to read profile data in an online network, an identifier for a member in the online network and a first non-global scope for accessing the profile data;
matching, by one or more computer systems, the identifier to a central profile record represented by a global scope for the profile data;
locating, by the one or more computer systems using the central profile record and the first non-global scope, a first scoped profile record for the member;
retrieving, by the one or more computer systems, a first field from the first scoped profile record and a second field from the central profile record; and
transmitting the first and second fields in a response to the first request without including, in the response, additional fields in profile records for the member that are outside of the first non-global scope or the global scope.

2. The method of claim 1, further comprising:
obtaining the identifier and a second non-global scope from a second request to update the profile data for the member;
matching the identifier and the second non-global scope to a second scoped profile record for the member; and
storing an update to the first field from the second request in the second scoped profile record without modifying the first field in the first scoped profile record.

3. The method of claim 1, further comprising:
obtaining the identifier and the first non-global scope from a second request to delete the profile data for the member; and
in response to the second request, deleting a mapping between the first scoped profile record and the central profile record without deleting the central profile record.

4. The method of claim 1, further comprising:
obtaining the identifier and a second non-global scope from a second request to read the profile data; and
when the identifier and the second non-global scope cannot be matched to a second scoped profile record for the member, indicating a lack of the profile data in an additional response to the second request.

5. The method of claim 1, wherein locating the first scoped profile record for the member using the central profile record and the first non-global scope comprises:
identifying a mapping associated with the central profile record and the first non-global scope; and
obtaining a location of the first scoped profile record using the mapping.

6. The method of claim 1, wherein the central profile record is stored in a central profile store and the first scoped profile record is stored in a scoped profile store.

7. The method of claim 1, wherein:
the first field from the first scoped profile is retrieved to override a value of the first field in the central profile record; and
the second field is retrieved from the central profile record upon detecting a lack of the second field in the first scoped profile record.

8. The method of claim 1, wherein the identifier comprises at least one of:
a member identifier with the online network;
an employee identifier;
an email address; and
a username.

9. The method of claim 1, wherein the first and second fields comprise at least one of:
a name;
a title;
a location;
a department;
a nickname;
a team name;
a standard profile field; and
a custom profile field.

10. The method of claim 1, wherein the first non-global scope comprises at least one of:
an account with the online network;
a product offered by the online network; and
a usage context within the product.

11. The method of claim 10, wherein the product comprises at least one of:
a recruiting product;
a marketing product;
an advertising product;
a sales product; and
an educational technology product.

12. The method of claim 10, wherein the account represents an entity with paid access to the product.

13. A method, comprising:
obtaining, from a first request to update profile data for a member of an online network, an identifier for the member and a first non-global scope;
matching, by one or more computer systems, the identifier to a central profile record with a global scope;
locating, by the one or more computer systems using the central profile record and the first non-global scope, a first scoped profile record for the member; and
storing, in the first scoped profile record, an update to a first field from the first request without modifying the first field in profile records for the member that are outside of the first non-global scope.

14. The method of claim 13, further comprising:
obtaining the identifier and a second non-global scope from a second request to read the profile data;
matching the identifier and the second non-global scope to a second scoped profile record for the member;
retrieving the first field from the second scoped profile record and a second field from the central profile record; and
transmitting the first and second fields in a response to the second request without including, in the response, additional fields in the profile records that are outside of the second non-global scope or the global scope.

15. The method of claim 14, wherein locating the second scoped profile record for the member using the central profile record and the second non-global scope comprises:
identifying a mapping associated with the central profile record and the second non-global scope; and
obtaining a location of the second scoped profile record from the mapping.

16. The method of claim 13, further comprising:
obtaining the identifier and the first non-global scope from a second request to delete the profile data for the member; and
in response to the second request, deleting a mapping between the first scoped profile record and the central profile record without deleting the central profile record.

17. The method of claim 13, wherein the central profile record comprises an enterprise member profile that is bound to a consumer member profile for the member with the online network.

18. The method of claim 13, wherein the first non-global scope comprises at least one of:
an account with the online network;
a product offered by the online network; and
a usage context within the product.

19. The method of claim 13, wherein the identifier comprises at least one of:
a member identifier with the online network;
an employee identifier;
an email address; and
a username.

20. A non-transitory computer-readable storage medium storing instructions that when executed by a computer cause the computer to perform a method, the method comprising:
obtaining, from a first request to read profile data in an online network, an identifier for a member in the online network and a first non-global scope;
matching the identifier to a central profile record represented by a global scope;
locating a first scoped profile record for the member using the central profile record and the first non-global scope;
retrieving a first field from the first scoped profile record and a second field from the central profile record; and
transmitting the first and second fields in a response to the first request without including, in the response, additional fields in profile records for the member that are outside of the first non-global scope or the global scope.
